(19) United States
(12) Patent Application Publication
(10) Pub. No.: US 2023/0027388 A1
(43) Pub. Date: Jan. 26, 2023

(54) PRICE INFORMATION DETERMINATION APPARATUS, PRICE INFORMATION DETERMINATION METHOD, AND NON-TRANSITORY COMPUTER READABLE MEDIUM

(71) Applicant: NEC Corporation, Minato-ku, Tokyo (JP)

(72) Inventors: Kan Arai, Tokyo (JP); Kei Shibuya, Tokyo (JP); Azusa Furukawa, Tokyo (JP); Hiroshi Hashimoto, Tokyo (JP); Makiko Akiguchi, Tokyo (JP); Ken Hanazawa, Tokyo (JP)

(73) Assignee: NEC Corporation, Minato-ku, Tokyo (JP)

(21) Appl. No.: 17/791,733

(22) PCT Filed: Jan. 23, 2020
(86) PCT No.: PCT/JP2020/002310

§ 371 Date: Jul. 8, 2022

(51) Int. Cl. G06Q 30/02; G09F 3/20

(52) U.S. Cl. CPC G06Q 30/0283; G06Q 30/0281; G06Q 30/0207; G09F 3/208

(57) ABSTRACT

A price information determination apparatus (10) includes an information acquisition unit (110), a price information determination unit (120), and an output unit (130). The information acquisition unit (110) acquires customer information of a customer when the customer selects a specific product (50) out of products (50) placed in a product shelving unit (40). The price information determination unit (120) generates price information of the selected product (50) by using the customer information acquired by the information acquisition unit (110). The output unit (130) outputs the customer information generated by the price information determination unit (120) to, for example, a display apparatus (30).

### TECHNICAL FIELD

The present invention relates to a price information determination apparatus, a price determination method, and a program.

### BACKGROUND ART

Various types of information about products are provided for a customer at a store. For example, Patent Document 1 describes acquiring information about a customer from a customer information card and, by using the information, changing information displayed on an electronic shelf tag. Further, Patent Document 2 describes causing an electronic shelf tag to display a special price when customer identification information satisfies a predetermined condition. Examples of the customer identification information described in Patent Document 2 include biometric information, magnetic information recorded on a magnetic stripe, characters recorded on a storage medium such as paper, and recorded information such as a bar code or a two-dimensional code.

Note that Patent Document 3 describes determining a product taken out from a showcase, by using image processing.

### RELATED DOCUMENTS

### Patent Documents

Patent Document 1: Japanese Patent Application Publication No. 2002-83368
Patent Document 2: Japanese Patent Application Publication No. 2007-122288
Patent Document 3: Japanese Patent Application Publication No. 2001-183051

### DISCLOSURE OF THE INVENTION

### Technical Problem

The present inventors have examined changing information about a price of a product depending on a customer to be provided with the information, at a location where the product is actually placed and the product is sold. At this time, it is important to decrease a load on the customer. An object of the present invention is to change information about a price of a product depending on a customer to be provided with the information while suppressing increase in a load on the customer, at a location where the product is actually placed and the product is sold.

### Solution to Problem

The present invention provides a price information determination apparatus including:

an information acquisition unit that, by using an image including a product placement location and an area around the product placement location, acquires customer information related to a customer when the customer selects a product placed at the product placement location;

a price information determination unit that generates price information related to a price of the product by using the customer information; and

an output unit that outputs the price information in a state recognizable to the customer.

The present invention provides a price information determination method including, by a computer:

by using an image including a product placement location and an area around the product placement location, acquiring customer information related to a customer when the customer selects a product placed at the product placement location;

generating price information related to a price of the product by using the customer information; and

outputting the price information in a state recognizable to the customer.

The present invention provides a program causing a computer to execute:

a function of, by using an image including a product placement location and an area around the product placement location, acquiring customer information related to a customer when the customer selects a product placed at the product placement location;

a function of generating price information related to a price of the product by using the customer information; and

a function of outputting the price information in a state recognizable to the customer.

### Advantageous Effects of Invention

The present invention enables changing information about a price of a product depending on a customer to be provided with the information while suppressing increase in a load on a customer, at a location where the product is actually placed and the product is sold.

### BRIEF DESCRIPTION OF THE DRAWINGS

The aforementioned object, other objects, features and advantages will become more apparent by use of the following preferred example embodiments and accompanying drawings.

FIG. 1 is a diagram illustrating an example of a use environment of a price information determination apparatus according to a first example embodiment.

FIG. 2 is a diagram illustrating a modified example of FIG. 1.

FIG. 3 is a diagram illustrating an example of a functional configuration of the price information determination apparatus.

FIG. 4 is a diagram illustrating a hardware configuration example of the price information determination apparatus.

FIG. 5 is a flowchart illustrating an example of processing performed by the price information determination apparatus.

FIG. 6 is a diagram illustrating a first example of display performed by a display apparatus.

FIG. 7 is a diagram illustrating a second example of display performed by the display apparatus.

FIG. 8 is a diagram illustrating a functional configuration of a price information determination apparatus according to a second example embodiment.

FIG. 9 is a flowchart illustrating an example of processing performed by the price information determination apparatus according to the second example embodiment.

FIG. 10 is a diagram illustrating a display example of a communication terminal as a display apparatus.

FIG. 11 is a diagram illustrating an image capture unit according to a third example embodiment.

FIG. 12 is a diagram illustrating a method for using the image capture unit.

### DESCRIPTION OF EMBODIMENTS

Example embodiments of the present invention are described below by using drawings. Note that in every drawing, similar components are given similar signs, and description thereof is not repeated as appropriate.

### First Example Embodiment

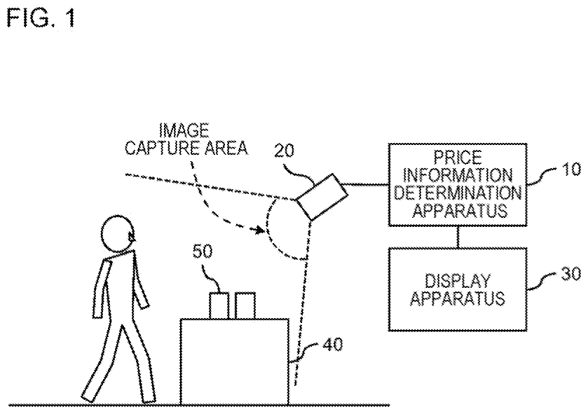

FIG. 1 is a diagram illustrating an example of a use environment of a price information determination apparatus 10 according to a first example embodiment. The price information determination apparatus 10 according to the present example embodiment determines price information of a product 50 and outputs the price information in a state recognizable to a customer, at a location where products are actually placed and the products are sold. For example, price information is information about a price of a product 50, examples which including at least one of the price of the product 50, a discount rate of the price of the product 50, and a benefit (such as points) provided by purchase of the product 50.

“A location where products are actually placed and the products are sold” may be a common store such as a convenience store or a supermarket, or a part of a location other than a common store, such as an office (for example, a so-called micro-store). In a case of the latter, for example, three or less (such as one) product shelving units 40 are placed at the location.

A product 50 is placed at a product placement location such as a product shelving unit 40. The following description assumes that the product placement location is the product shelving unit 40. Then, when a customer selects a specific product 50 out of products 50 placed in the product shelving unit 40, the price information determination apparatus 10 acquires information about the customer (hereinafter described as customer information) and generates price information of the selected product 50 by using the customer information.

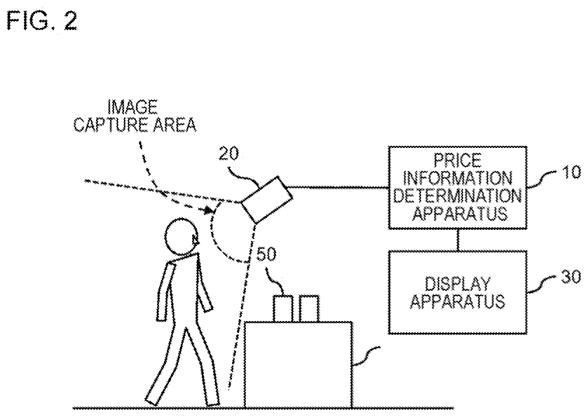

In the example illustrated in this diagram, an image generated by an image capture unit 20, that is, an image capture area of the image capture unit 20 includes an area around the product shelving unit 40. As an example, the image includes the product shelving unit 40 and a product 50 placed in the product 50, and the front of the product shelving unit 40 (that is, a location where a customer taking out a product 50 from the product shelving unit 40 exists). Note that, as illustrated in FIG. 2, the image may not include the product shelving unit 40.

A customer is captured in an image generated by the image capture unit 20. Then, the price information determination apparatus 10 acquires customer information by using the image generated by the image capture unit 20. As an example, the price information determination apparatus 10 generates customer information by processing at least an area corresponding to the customer in the image. The customer information includes attributes of a customer such as a gender and an age group.

Further, a product 50 selected by a customer is also captured in the image generated by the image capture unit 20. Therefore, the price information determination apparatus 10 can identify the product 50 selected by the customer by processing the image.

For example, by processing an area corresponding to an area around the product shelving unit 40 in an image generated by the image capture unit 20, the price information determination apparatus 10 can identify a product 50 taken out from the product shelving unit 40 by a customer, that is, a product held by the customer and identify the product as a product 50 selected by the customer. Further, by processing an area corresponding to the product shelving unit 40 in an image generated by the image capture unit 20, the price information determination apparatus 10 can identify a product touched by a customer out of products 50 placed in the product shelving unit 40 and identify the product as a product 50 selected by the customer. Further, when the face of a customer is captured in an image generated by the image capture unit 20, the price information determination apparatus 10 may detect a line of sight of the customer by processing an area corresponding to the face of the customer in the image and identify a product 50 selected by the customer by using the line of sight. For example, the price information determination apparatus 10 identify a product 50 meeting a line of sight of a customer out of products 50 in the product shelving unit 40 and selects the product as a product 50 selected by the customer.

Then, the price information determination apparatus 10 outputs the generated price information to a display apparatus 30. The display apparatus 30 displays the price information. For example, the display apparatus 30 may be provided on the product shelving unit 40. As an example, the display apparatus 30 is an electronic shelf tag. In this case, the display apparatus 30 is provided for each product type. Further, the display apparatus 30 may be a tablet or a display provided on the product shelving unit 40. In this case, the display apparatus 30 may be a larger screen compared with an electronic shelf tag and may provide price information for a plurality of customers. Note that, for example, one tablet or display as the display apparatus 30 may be provided for the product shelving unit 40 or a plurality of display apparatuses 30 may be provided. When a plurality of display apparatuses 30 are provided, pieces of price information different from each other can be provided for a plurality of customers. As an example, the price information determination apparatus 10 causes a display apparatus 30 positioned on the relatively right side to display customer information to be provided for a customer positioned on the right side and causes a display apparatus 30 positioned on the relatively left side to display customer information to be provided for a customer positioned on the left side.

Further, the display apparatus 30 may be a projector provided near the product shelving unit 40 or a mobile terminal (such as a smartphone) carried by a customer.

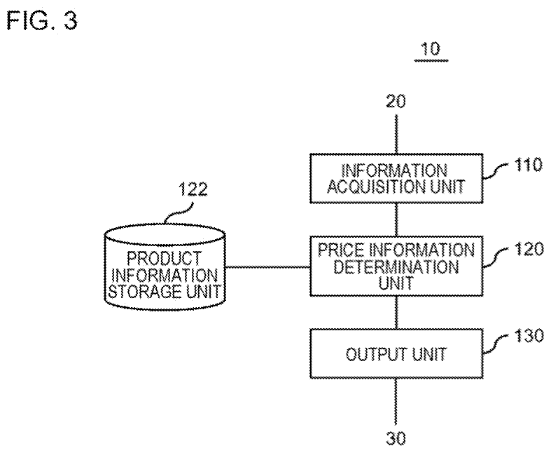

FIG. 3 is a diagram illustrating an example of a functional configuration of the price information determination apparatus 10. The price information determination apparatus 10 includes an information acquisition unit 110, a price information determination unit 120, and an output unit 130. When a customer selects a specific product 50 out of products 50 placed in the product shelving unit 40, the information acquisition unit 110 acquires customer information of the customer by using an image generated by the image capture unit 20, that is, an image including the product shelving unit 40 and an area around the product shelving unit 40. The price information determination unit 120 determines price information of a selected product 50 by using customer information acquired by the information acquisition unit 110. The price information determination unit 120 may generate price information or select price information out of a plurality of previously prepared pieces of price information. The output unit 130 outputs price information determined by the price information determination unit 120 to, for example, the display apparatus 30.

As an example, the information acquisition unit 110 generates customer information by using an image generated by the image capture unit 20. An example of the generation method is as described by using FIG. 1 and FIG. 2. Further, examples of the customer information generated here include attributes of a customer such as a gender and an age group as described by using FIG. 1 and FIG. 2. Further, the information acquisition unit 110 identify a product 50 selected by a customer by processing an image generated by the image capture unit 20. An example of the identification method is as described by using FIG. 1 and FIG. 2. Then, the information acquisition unit 110 generates information indicating the product 50 selected by the customer (hereinafter described as product identification information). The product identification information may be discrimination information assigned for each type of product 50, such as a code provided for each type of product 50 [such as a Japanese article number (JAN) code].

The price information determination unit 120 determines price information by using customer information and product identification information generated by the information acquisition unit 110. When determining price information, the price information determination unit 120 further uses information stored in a product information storage unit 122.

For each piece of product identification information, the product information storage unit 122 stores information required for determining price information of the product 50 (hereinafter described as price-determining information). Examples of the price-determining information include a standard price and a standard benefit (such as awarded points) of a product 50, and a price and a benefit (such as awarded points) of the product 50 for each piece of customer information (for example, for each attribute).

As price-determining information, the product information storage unit 122 may store a function with customer information as a parameter, and a price and points as outputs, for example, for each product 50. Note that the product information storage unit 122 may store a function common to a plurality of products 50. In this case, the function further includes a standard price and standard points of a product 50 as parameters. Thus, a function does not need to be provided for each product 50. Note that the product information storage unit 122 may store price information in a table format. In this case, the product information storage unit 122 stores a table for each product 50. Then, for example, the product information storage unit 122 may store price information (such as a price and points of a product) for each attribute of a customer.

Further, for each type of product 50 (for example, for each JAN code), the product information storage unit 122 may store information about at least one item out of inventory of the product 50 and sales performance of the product 50 (hereinafter described as sales information). In this case, the product information storage unit 122 may store information for reflecting sales information in price information, such as a function with sales information as a parameter, and a price and points as outputs.

In the example illustrated in this diagram, the product information storage unit 122 is part of the price information determination apparatus 10. However, the product information storage unit 122 may be provided outside the price information determination apparatus 10.

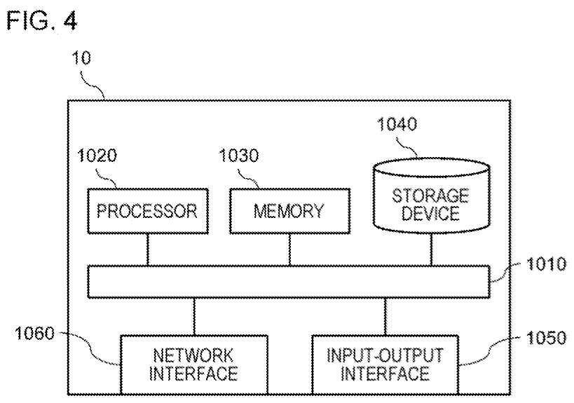

FIG. 4 is a diagram illustrating a hardware configuration example of the price information determination apparatus 10. The price information determination apparatus 10 includes a bus 1010, a processor 1020, a memory 1030, a storage device 1040, an input-output interface 1050, and a network interface 1060.

The bus 1010 is a data transmission channel for the processor 1020, the memory 1030, the storage device 1040, the input-output interface 1050, and the network interface 1060 to transmit and receive data to and from one another. Note that the method of interconnecting the processor 1020 and other components is not limited to a bus connection.

The processor 1020 is a processor configured with a central processing unit (CPU), a graphics processing unit (GPU), or the like.

The memory 1030 is a main storage provided by a random access memory (RAM) or the like.

The storage device 1040 is an auxiliary storage configured with a hard disk drive (HDD), a solid state drive (SSD), a memory card, a read only memory (ROM), or the like. The storage device 1040 stores program modules providing the functions of the price information determination apparatus 10 (such as the information acquisition unit 110, the price information determination unit 120, and the output unit 130). By reading each program module into the memory 1030 and executing the program module by the processor 1020, each function related to the program module is provided. Further, the storage device 1040 also functions as the product information storage unit 122 and a customer information storage unit 112 described in another example embodiment.

The input-output interface 1050 is an interface for connecting the price information determination apparatus 10 to various types of input-output equipment (such as the image capture unit 20 and the display apparatus 30).

The network interface 1060 is an interface for connecting the price information determination apparatus 10 to a network. Example of the network include a local area network (LAN) and a wide area network (WAN). The method of connecting the network interface 1060 to the network may be a wireless connection or a wired connection. Note that the price information determination apparatus 10 may be connected to at least one of the image capture unit 20 and the display apparatus 30 through the network interface 1060.

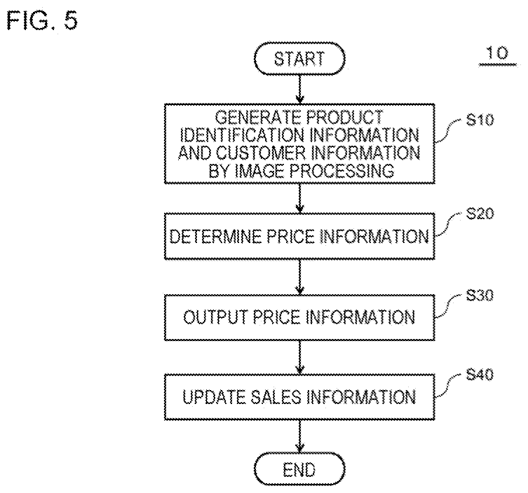

FIG. 5 is a flowchart illustrating an example of processing performed by the price information determination apparatus 10. In the processing illustrated in this diagram, the image capture unit 20 repeatedly generates images (such as static images constituting a dynamic image) during sale of products 50. Then, the information acquisition unit 110 in the price information determination apparatus 10 continues receiving images generated by the image capture unit 20 and continues processing the images.

Then, the information acquisition unit 110 detects a customer approaching the product shelving unit 40. For example, the information acquisition unit 110 detects that a customer is included in an image. Then, by image processing, the information acquisition unit 110 detects that the customer selects a product 50 in the product shelving unit 40. Then, by image processing, the information acquisition unit 110 generates customer information of the customer selecting the product 50 and product identification information of the product 50 selected by the customer (Step S10).

Next, the price information determination unit 120 determines price information by using the customer information and the product identification information generated by the information acquisition unit 110 (Step S20). For example, the price information determination unit 120 reads price-determining information related to the product identification information generated by the information acquisition unit 110 from the product information storage unit 122. Then, the price information determination unit 120 determines price information by using the read price-determining information and the customer information generated by the information acquisition unit 110. For example, the price information determination unit 120 reads a function with price information as a parameter from the product information storage unit 122 and generates price information by using the function and the price information. Further, for example, when the product information storage unit 122 stores price information and customer information in association with each other in a table format, the price information determination unit 120 determines price information by reading price information related to the customer information from the product information storage unit 122. Further, as described by using FIG. 3, the price information determination unit 120 may further use sales information of the product 50 when determining price information. Note that the price information determination unit 120 may include, in price information, information indicating expiration dates of a price, a discount rate, and a benefit that are indicated by the price information. For example, the expiration date may be previously stored as a specific date or may be computed by adding a predetermined period to the current time.

Then, the output unit 130 outputs the price information generated by the price information determination unit 120 to the display apparatus 30 and causes the display apparatus 30 to display the price information (Step S30).

After the display apparatus 30 displays the price information, the price information determination apparatus 10 or another apparatus acquires information indicating whether the customer purchases the product 50. The apparatus acquiring the information causes the product information storage unit 122 to store the information linked to the displayed price information as at least part of the sales information (Step S40).

Note that when the customer information generated in Step S10 does not satisfy a criterion (for example, the gender is different from a target or the age group is outside a criterion), the processing in and after Step S20 does not need to be performed.

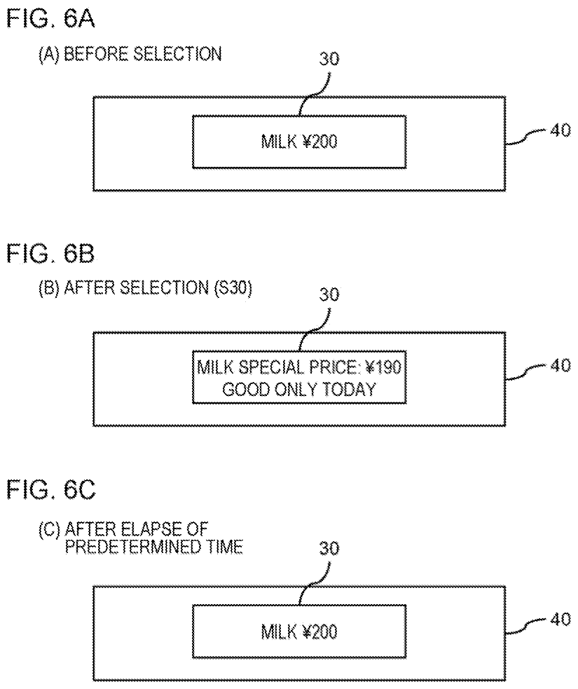

FIG. 6 is a diagram illustrating a first example of display performed by the display apparatus 30. In the example illustrated in this diagram, the display apparatus 30 is provided on the product shelving unit 40. At this time, for each type of product 50, a display apparatus 30 is installed at a position related to the product 50. In other words, the display apparatus 30 functions as an electronic shelf tag. However, the display apparatus 30 may be a tablet or a display, as described above.

In the example illustrated in this diagram, the price information determination apparatus 10 provides a price, a discount rate, or awarded points different from a regular price, a regular discount rate, or regular awarded points for a customer satisfying a specific condition.

First, when a customer is not approaching or when customer information of a customer selecting a product 50 does not satisfy a criterion, the output unit 130 in the price information determination apparatus 10 causes the display apparatus 30 to display at least one item out of a regular (in other words, without using the customer information) price, a regular discount rate, and regular awarded points, as illustrated in FIG. 6(A).

Then, when the customer selecting the product 50 satisfies a specific condition, the output unit 130 causes the display apparatus 30 to display price information (such as at least one item out of a special price, a special discount rate, and special awarded points) for the customer, as illustrated in FIG. 6(B). Note that the display illustrated in this diagram includes an expiration date of the price information.

Subsequently, when a reference time (such as any time equal to or greater than 5 seconds and equal to or less than 1 minute) elapses in the state in FIG. 6(B), the output unit 130 returns the display of the display apparatus 30 to display not using the price information, such as the state in FIG. 6(A), as illustrated in FIG. 6(C). Note that a trigger by which the output unit 130 returns the display of the display apparatus 30 is not limited to exceeding a reference time. For example, the trigger may be the customer being distant from the product shelving unit 40 by a reference distance or greater, or the customer ending selection of a product 50 (for example, the line of sight of the customer being continuously kept off the selected product 50 for a certain period of time).

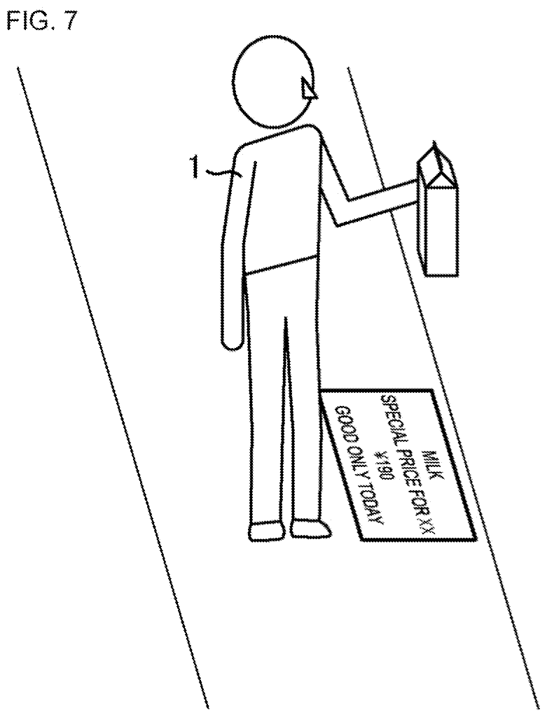

FIG. 7 is a diagram illustrating a second example of display performed by the display apparatus 30. In the example illustrated in this diagram, the display apparatus 30 is a projector provided near the product shelving unit 40 and projects display using price information onto an aisle or a wall near the product shelving unit 40, the body of a customer, or a product. In this case, the output unit 130 may also perform control described by using the diagrams in FIG. 6.

Note that in the examples described above, the price information determination apparatus 10 generates customer information and identify a product 50 selected by a customer, by processing an image generated by one image capture unit 20. However, the price information determination apparatus 10 may acquire an image for generating customer information (hereinafter described as a first image) and an image for identifying a product 50 selected by a customer (hereinafter described as a second image) from image capture units 20 different from each other, respectively. In this case, for example, a first image is generated by an image capture unit 20 having a customer aisle as an image capture area, and a second image is generated by an image capture unit 20 having the product shelving unit 40 as an image capture area.

As described above, the price information determination apparatus 10 according to the present example embodiment identifies that a customer selects a product 50 in the product shelving unit 40, by image processing. Then, the price information determination apparatus 10 determines price information of the selected product 50 by using customer information of the customer. Then, the price information determination apparatus 10 outputs the generated price information in a state recognizable to the customer by using the display apparatus 30. Accordingly, the price information determination apparatus 10 can change information about a price for each product, depending on a customer to be provided with the information while suppressing increase in a load on the customer.

### Second Example Embodiment

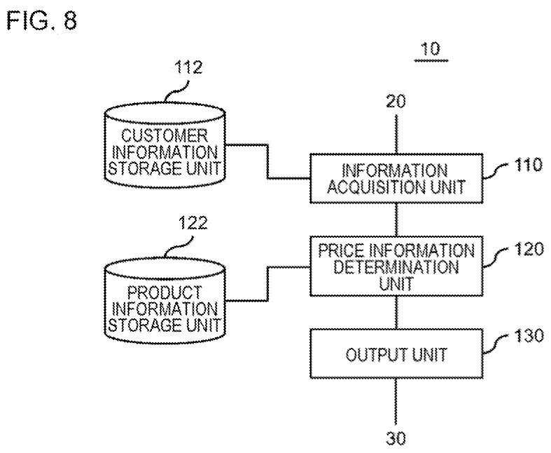

FIG. 8 is a diagram illustrating a functional configuration of a price information determination apparatus 10 according to a second example embodiment and is related to FIG. 3 in the first example embodiment. The price information determination apparatus 10 according to the present example embodiment is similar to the price information determination apparatus 10 according to the first example embodiment except for individually identifying a customer and determining price information by further using customer information of the identified customer.

Specifically, the price information determination apparatus 10 uses a customer information storage unit 112. For each customer, the customer information storage unit 112 stores information about the customer. Examples of information stored in the customer information storage unit 112 include a feature value of the face of a customer, attributes (such as a gender and an age), and a purchase history of the customer. The customer information storage unit 112 may include at least one of a name of the customer, an ID of the customer, and a nickname of the customer. Then, an information acquisition unit 110 generates price information by using information stored in the customer information storage unit 112.

Further, for each customer, the customer information storage unit 112 may store communication terminal information [such as an email address or a social networking service (SNS) account] for communicating with a mobile terminal of the customer. In this case, an output unit 130 transmits price information to the mobile terminal of the customer and causes the mobile terminal to display the price information, by using information stored in the customer information storage unit 112.

In the example illustrated in this diagram, the customer information storage unit 112 is part of the price information determination apparatus 10. However, the customer information storage unit 112 may be provided outside the price information determination apparatus 10.

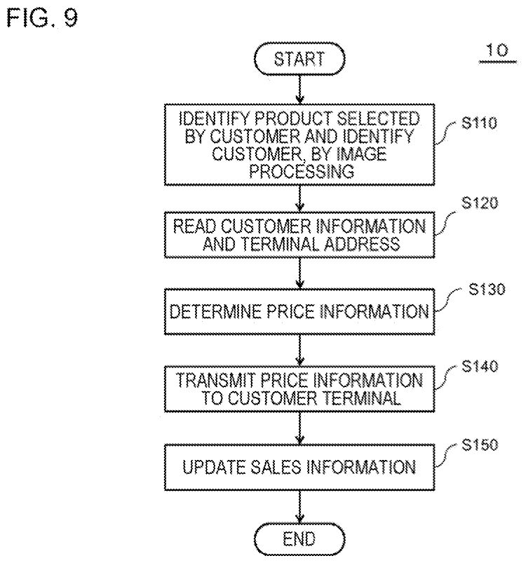

FIG. 9 is a flowchart illustrating an example of processing performed by the price information determination apparatus 10 according to the present example embodiment. First, by processing an image generated by an image capture unit 20, the information acquisition unit 110 in the price information determination apparatus 10 identifies a product 50 selected by a customer. Further, by processing the image by using a feature value of the face, the information acquisition unit 110 identifies the customer selecting the product 50. The method for identifying a product 50 is as described in the first example embodiment (Step S110).

Next, the information acquisition unit 110 reads information related to the identified customer from the customer information storage unit 112. The read information includes an attribute of the customer, a purchase history of the customer, and communication terminal information (Step S120).

Next, the price information determination unit 120 in the price information determination apparatus 10 determines price information by using the attribute of the customer and the purchase history of the customer that are read in Step S120. For example, the product information storage unit 122 stores, as price-determining information, a function with an attribute of a customer and a purchase history of the customer as parameters and a price and points as outputs. The price information determination unit 120 determines price information by using the price-determining information, the attribute of the customer, and the purchase history of the customer (Step S130).

Next, the output unit 130 transmits the price information to a communication terminal of the customer as the display apparatus 30 by using the communication terminal information read in Step S120 (Step S140). Subsequently, processing similar to Step S40 in FIG. 5 is performed (Step S150).

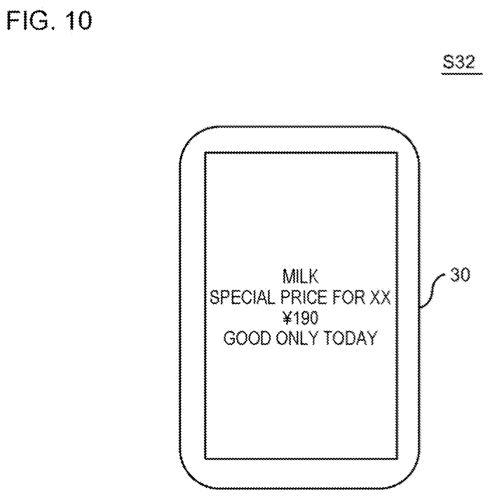

FIG. 10 is a diagram illustrating a display example of a communication terminal as the display apparatus 30. In the example illustrated in this diagram, the price information determination unit 120 in the price information determination apparatus 10 reads at least one of a name of the customer, an ID of the customer, and a nickname of a customer from the customer information storage unit 112 and includes the read information in price information. Further, the price information illustrated in this diagram also includes an expiration date of the price information.

The present example embodiment also enables changing information about a price for each product depending on a customer to be provided with the information while suppressing increase in a load on the customer, similarly to the first example embodiment. Further, the price information determination unit 120 determines price information by using customer information stored in the customer information storage unit 112. Accordingly, price information can be more minutely set.

Note that the examples described in the first example embodiment, such as an electronic shelf tag, a tablet or a display provided on the product shelving unit 40, and a projector provided near the product shelving unit 40 may apply as the display apparatus 30 according to the present example embodiment. In this case, price information preferably also includes at least one of a name of a customer, an ID of the customer, and the nickname of a customer, as illustrated in FIG. 10.

### Third Example Embodiment

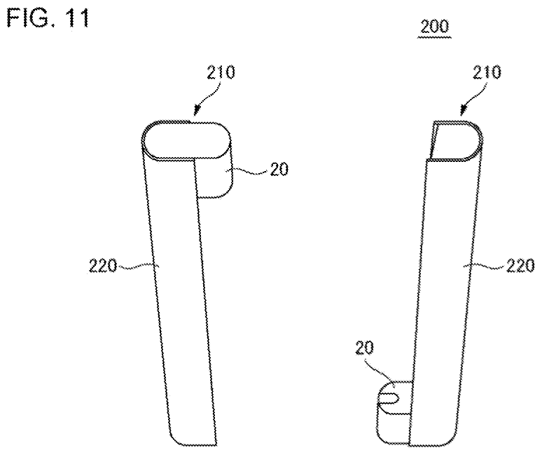

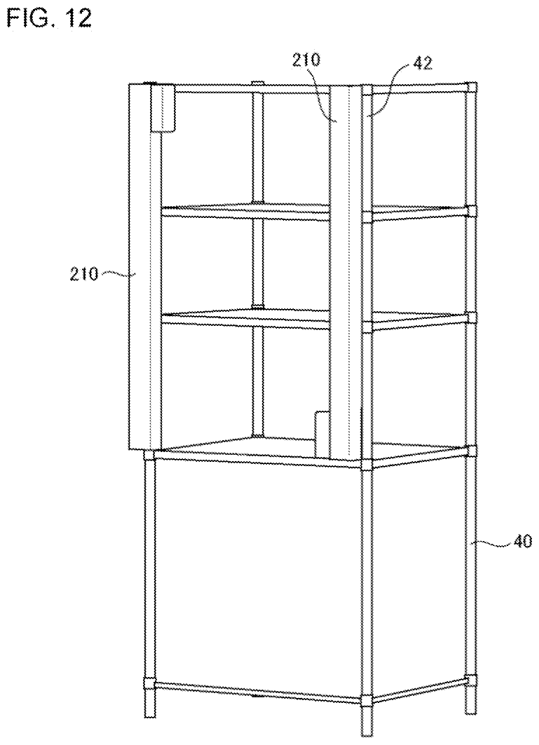

FIG. 11 is a diagram illustrating an image capture unit 20 according to a third example embodiment. FIG. 12 is a diagram illustrating a method for using the image capture unit 20. The image capture unit 20 used with a price information determination apparatus 10 is part of an image capture apparatus 200, according to the present example embodiment.

More specifically, the image capture apparatus 200 includes two units for image-capturing 210. Each of the two units for image-capturing 210 includes a lighting unit 220 and the image capture unit 20.

A light emitting surface of the lighting unit 220 extends in one direction and includes a light emitting unit and a cover for covering the light emitting unit. The lighting unit 220 mainly emits light in a direction orthogonal to the extending direction of the light emitting surface. The light emitting unit includes a light emitting device such as an LED and emits light in a direction not covered by the cover. Note that when the light emitting device is an LED, a plurality of LEDs are arranged in the extending direction of the lighting unit 220 (the vertical direction in the diagram).

Then, the image capture unit 20 is provided at one end of the lighting unit 220 and has, as an image capture area, a direction in which light from the lighting unit 220 is emitted. For example, in a unit for image-capturing 210 on the left side in FIG. 11, the image capture unit 20 has lower area and a diagonally lower right area as an image capture area. Further, in a unit for image-capturing 210 on the right side in FIG. 11, the image capture unit 20 has an upper area and a diagonally upper left area as an image capture area.

As illustrated in FIG. 12, the two units for image-capturing 210 are mounted on front frames 42 (or at the front of side walls on both sides) of the product shelving unit 40. At this time, a first unit for image-capturing 210 is mounted on one front frame 42 and is oriented in such a way that the image capture unit 20 is positioned in the lower part, and a second unit for image-capturing 210 is mounted on a front frame 42 on the opposite side to the first unit for image-capturing 210 and is orientated in such a way that the image capture unit 20 is positioned in the upper part. Then, the image capture unit 20 in the first unit for image-capturing 210 captures an image of an upper area and a diagonally upper area in such a way that an opening of the product shelving unit 40 is included in the image capture area. On the other hand, the image capture unit 20 in the second unit for image-capturing 210 captures an image of a lower area and a diagonally lower area in such a way that the opening of the product shelving unit 40 is included in the image capture area. Thus using two units for image-capturing 210 enables image capture of the entire area of the opening of the product shelving unit 40.

Then, the price information determination apparatus 10 generates various types of information described in the aforementioned example embodiments by processing an image captured by the image capture unit 20 in each of the two units for image-capturing 210, that is, images captured by the two image capture units 20. For example, the image capture unit 20 in the first unit for image-capturing 210 captures an image of an upper area and a diagonally upper area. Therefore, a customer is captured in the image generated by the image capture unit 20. Therefore, the price information determination apparatus 10 can determine customer information by processing the image generated by the image capture unit 20.

As described above, the present example embodiment also provides effects similar to those provided by the aforementioned example embodiments.

While the example embodiments of the present invention have been described above with reference to the drawings, the example embodiments are exemplifications of the present invention, and various configurations other than those described above may be employed.

Further, while a plurality of steps (processing) are described in a sequential order in each of a plurality of flowcharts used in the aforementioned description, the execution order of steps executed in each example embodiment is not limited to the described order. The order of the illustrated steps in each example embodiment may be modified without affecting the contents. Further, the aforementioned example embodiments may be combined without contradicting one another.

The whole or part of the example embodiments described above may be described as, but not limited to, the following supplementary notes.

1. A price information determination apparatus including:

an information acquisition unit that, by using an image includes a product placement location and an area around the product placement location, acquires customer information related to a customer when the customer selects a product placed at the product placement location;

a price information determination unit that determines price information related to a price of the product by using the customer information; and

an output unit that outputs the price information in a state recognizable to the customer.

2. The price information determination apparatus according to aforementioned 1, in which

the price information includes at least one of a price of the product, a discount rate of a price of the product, and a benefit provided by purchase of the product.

3. The price information determination apparatus according to aforementioned 2, in which

the price information includes information indicating an expiration date of the at least one of a price of the product, a discount rate of a price of the product, and a benefit provided by purchase of the product.

4. The price information determination apparatus according to any one of aforementioned 1 to 3, in which

the output unit causes a display apparatus installed at the product placement location to display the price information.

5. The price information determination apparatus according to any one of aforementioned 1 to 3, in which

the output unit causes a display apparatus installed at a position related to the product to display the price information.

6. The price information determination apparatus according to any one of aforementioned 1 to 3, in which

the output unit projects the price information by using a projector.

7. The price information determination apparatus according to any one of aforementioned 1 to 3, in which

the output unit acquires mobile terminal information for communicating with a mobile terminal linked to the customer and transmits the price information to the mobile terminal by using the mobile terminal information.

8. The price information determination apparatus according to any one of aforementioned 1 to 7, in which

the output unit
outputs information different from the price information before outputting the price information and
outputs information different from the price information in place of the price information when a reference time elapses after output of the price information is started, when the customer is distant from the product placement location by a reference distance or greater, or when the customer ends selection of the product.
   9. The price information determination apparatus according to aforementioned 8, in which

the output unit causes a price of the product which does not use the customer information to be displayed when not outputting the price information.

10. The price information determination apparatus according to any one of aforementioned 1 to 9, in which,

by processing the image, the information acquisition unit generates product identification information for identifying the product selected by the customer, and

the price information determination unit generates the price information by using the product identification information.

11. The price information determination apparatus according to any one of aforementioned 1 to 10, in which

the customer information includes at least one of a gender, an age group, and a purchase history.

12. The price information determination apparatus according to any one of aforementioned 1 to 11, in which

the price information determination unit generates the price information by further using information about at least one item out of inventory of the product and sales performance of the product.

13. The price determination apparatus according to any one of aforementioned 1 to 12, in which

the price information includes at least one of a name of the customer, an ID of the customer, and a nickname of the customer.

14. The price information determination apparatus according to any one of aforementioned 1 to 13, in which

the price information determination unit determines the price information by using a function with the customer information as a parameter.

15. The price information determination apparatus according to any one of aforementioned 1 to 13, in which

the price information determination unit determines the price information by reading, from a database associating the price information with the customer information, the price information related to the customer information acquired by the information acquisition unit.

16. A price information determination method including, by a computer:

by using an image including a product placement location and an area around the product placement location, acquiring customer information related to a customer when the customer selects a product placed at the product placement location;

generating price information related to a price of the product by using the customer information; and

outputting the price information in a state recognizable to the customer.

17. The price information determination method according to aforementioned 16, in which

the price information includes at least one of a price of the product, a discount rate of a price of the product, and a benefit provided by purchase of the product.

18. The price information determination method according to aforementioned 17, in which

the price information includes information indicating an expiration date of the at least one of a price of the product, a discount rate of a price of the product, and a benefit provided by purchase of the product.

19. The price information determination method according to any one of aforementioned 16 to 18, further including, by the computer,

causing a display apparatus installed at the product placement location to display the price information.

20. The price information determination method according to any one of aforementioned 16 to 18, further including, by the computer,

causing a display apparatus installed at a position related to the product to display the price information.

21. The price information determination method according to any one of aforementioned 16 to 18, further including, by the computer,

projecting the price information by using a projector.

22. The price information determination method according to any one of aforementioned 16 to 18, further including, by the computer,

acquiring mobile terminal information for communicating with a mobile terminal linked to the customer and transmitting the price information to the mobile terminal by using the mobile terminal information.

23. The price information determination method according to any one of aforementioned 16 to 22, further including, by the computer:

outputting information different from the price information before outputting the price information; and

outputting information different from the price information in place of the price information when a reference time elapses after output of the price information is started, when the customer is distant from the product placement location by a reference distance or greater, or when the customer ends selection of the product.

24. The price information determination method according to aforementioned 23, further including, by the computer,

causing a price of the product which does not use the customer information to be displayed when not outputting the price information.

25. The price information determination method according to any one of aforementioned 16 to 24, further including, by the computer:

by processing the image, generating product identification information for identifying the product selected by the customer; and

generating the price information by using the product identification information.

26. The price information determination method according to any one of aforementioned 16 to 25, in which

the customer information includes at least one of a gender, an age group, and a purchase history.

27. The price information determination method according to any one of aforementioned 16 to 26, further including, by the computer,

generating the price information by further using information about at least one item out of inventory of the product and sales performance of the product.

28. The price information determination method according to any one of aforementioned 16 to 27, in which

the price information includes at least one of a name of the customer, an ID of the customer, and a nickname of the customer.

29. The price information determination method according to any one of aforementioned 16 to 28, further including, by the computer,

determining the price information by using a function with the customer information as a parameter.

30. The price information determination method according to any one of aforementioned 16 to 28, further including, by the computer,

determining the price information by reading, from a database associating the price information with the customer information, the price information related to the customer information acquired by the computer.

31. A program causing a computer to execute:

a function of, by using an image including a product placement location and an area around the product placement location, acquiring customer information related to a customer when the customer selects a product placed at the product placement location;

a function of generating price information related to a price of the product by using the customer information; and

a function of outputting the price information in a state recognizable to the customer.

32. The program according to aforementioned 31, in which

the price information includes at least one of a price of the product, a discount rate of a price of the product, and a benefit provided by purchase of the product.

33. The program according to aforementioned 32, in which

the price information includes information indicating an expiration date of the at least one of a price of the product, a discount rate of a price of the product, and a benefit provided by purchase of the product.

34. The program according to any one of aforementioned 31 to 33, further causing the computer to

cause a display apparatus installed at the product placement location to display the price information.

35. The program according to any one of aforementioned 31 to 33, further causing the computer to

cause a display apparatus installed at a position related to the product to display the price information.

36. The program according to any one of aforementioned 31 to 33, further causing the computer to

project the price information by using a projector.

37. The program according to any one of aforementioned 31 to 33, further causing the computer to

acquire mobile terminal information for communicating with a mobile terminal linked to the customer and transmit the price information to the mobile terminal by using the mobile terminal information.

38. The program according to any one of aforementioned 31 to 37, further causing the computer to:

output information different from the price information before outputting the price information; and

output information different from the price information in place of the price information when a reference time elapses after output of the price information is started, when the customer is distant from the product placement location by a reference distance or greater, or when the customer ends selection of the product.

39. The program according to aforementioned 38, further causing the computer to

cause a price of the product which does not use the customer information to be displayed when not outputting the price information.

40. The program according to any one of aforementioned 31 to 39, further causing the computer to:

by processing the image, generate product identification information for identifying the product selected by the customer; and

generate the price information by using the product identification information.

41. The program according to any one of aforementioned 31 to 40, in which the customer information includes at least one of a gender, an age group, and a purchase history.
42. The program according to any one of aforementioned 31 to 41, further causing the computer to

generate the price information by further using information about at least one item out of inventory of the product and sales performance of the product.

43. The program according to any one of aforementioned 31 to 42, in which

the price information includes at least one of a name of the customer, an ID of the customer, and a nickname of the customer.

44. The program according to any one of aforementioned 31 to 43, further causing the computer to

determine the price information by using a function with the customer information as a parameter.

45. The program according to any one of aforementioned 31 to 43, further causing the computer to

determine the price information by reading, from a database associating the price information with the customer information, the price information related to the customer information acquired by the computer.

### REFERENCE SIGNS LIST

10 Price information determination apparatus
20 Image capture unit
30 Display apparatus
40 Product shelving unit
42 Front frame
50 Product
110 Information acquisition unit
112 Customer information storage unit
120 Price information determination unit
122 Product information storage unit
130 Output unit
200 Image capture apparatus
210 Unit for image-capturing
220 Lighting unit

What is claimed is:

1. A price information determination apparatus comprising:
at least one memory configured to store instructions; and
at least one processor configured to execute the instructions to perform operations comprising:
acquiring, by using an image includes a product placement location and an area around the product placement location, customer information related to a customer when the customer selects a product placed at the product placement location;
determining price information related to a price of the product by using the customer information; and
outputting the price information in a state recognizable to the customer.

2. The price information determination apparatus according to claim 1, wherein
the price information includes at least one of a price of the product, a discount rate of a price of the product, and a benefit provided by purchase of the product.

3. The price information determination apparatus according to claim 2, wherein
the price information includes information indicating an expiration date of the at least one of a price of the product, a discount rate of a price of the product, and a benefit provided by purchase of the product.

4. The price information determination apparatus according to claim 1, wherein outputting the price information comprises
causing a display apparatus installed at the product placement location to display the price information.

5. The price information determination apparatus according to claim 1, wherein outputting the price information comprises
causing a display apparatus installed at a position related to the product to display the price information.

6. The price information determination apparatus according to claim 1, wherein outputting the price information comprises
projecting the price information by using a projector.

7. The price information determination apparatus according to claim 1, wherein outputting the price information comprises:
acquiring mobile terminal information for communicating with a mobile terminal linked to the customer; and
transmitting the price information to the mobile terminal by using the mobile terminal information.

8. The price information determination apparatus according to claim 1, wherein the operations further comprise:
outputting information different from the price information before outputting the price information; and
outputting information different from the price information in place of the price information when a reference time elapses after output of the price information is started, when the customer is distant from the product placement location by a reference distance or greater, or when the customer ends selection of the product.

9. The price information determination apparatus according to claim 8, wherein the operation further comprise:
causing a price of the product which does not use the customer information to be displayed when not outputting the price information.

10. The price information determination apparatus according to claim 1, wherein the operation further comprise,
by processing the image, generating product identification information for identifying the product selected by the customer; and
generating the price information by using the product identification information.

11. The price information determination apparatus according to claim 1, wherein
the customer information includes at least one of a gender, an age group, and a purchase history.

12. The price information determination apparatus according to claim 1, wherein the operations further comprise
generating the price information by further using information about at least one item out of inventory of the product and sales performance of the product.

13. The price information determination apparatus according to claim 1, wherein
the price information includes at least one of a name of the customer, an ID of the customer, and a nickname of the customer.

14. The price information determination apparatus according to claim 1, wherein the operations further comprise
determining the price information by using a function with the customer information as a parameter.

15. The price information determination apparatus according to claim 1, wherein the operations further comprise
determining the price information by reading, from a database associating the price information with the customer information, the price information related to the customer information.

16. A price information determination method comprising, by a computer:
by using an image including a product placement location and an area around the product placement location, acquiring customer information related to a customer when the customer selects a product placed at the product placement location;
generating price information related to a price of the product by using the customer information; and
outputting the price information in a state recognizable to the customer.

17. A non-transitory computer readable medium storing a program causing a computer to execute operations comprising:
acquiring, by using an image including a product placement location and an area around the product placement location, customer information related to a customer when the customer selects a product placed at the product placement location;
generating price information related to a price of the product by using the customer information; and
outputting the price information in a state recognizable to the customer.
